(19) United States
(12) Patent Application Publication
(10) Pub. No.: US 2019/0372411 A1
(43) Pub. Date: Dec. 5, 2019

(54) ROTOR AND MOTOR USING SAME

(71) Applicant: Nidec Corporation, Kyoto (JP)

(72) Inventor: Tomoya UEDA, Kyoto (JP)

(21) Appl. No.: 16/461,847

(22) PCT Filed: Jan. 12, 2018
(86) PCT No.: PCT/JP2018/000570

§ 371 Date: May 17, 2019

(30) Foreign Application Priority Data
Jan. 20, 2017 (JP) 2017-008443

(51) Int. Cl. H02K 1/24; H02K 1/27; H02K 1/26

(52) U.S. Cl. CPC H02K 1/24; H02K 1/26; H02K 1/27

(57) ABSTRACT

A rotor includes a cylindrical rotor core including salient pole portions protruding in a radial direction and extending along a central axis, and rotor magnets alternately arranged with the salient pole portions in a circumferential direction on an outer circumferential surface of the rotor core. The rotor core includes a cylindrical core portion, a first space penetrating the core portion in an axial direction and located radially inward of the core portion with respect to the salient pole portions, a second space penetrating the core portion in the axial direction and located radially inward of the core portion with respect to the rotor magnets, and a slit extending from the first space to an outer circumferential surface of the salient pole portion and being open to the outer surface.

### CROSS REFERENCE TO RELATED APPLICATIONS

This is the U.S. national stage of application No. PCT/JP2018/000570, filed on Jan. 12, 2018, and priority under 35 U.S.C. § 119(a) and 35 U.S.C. § 365(b) is claimed from Japanese Application No. 2017-008443, filed Jan. 20, 2017; the contents of which are incorporated herein by reference.

### 1. FIELD OF THE INVENTION

The present disclosure relates to a rotor and a motor using the same.

### 2. DESCRIPTION OF THE RELATED ART

In the related art, a configuration including a rotor core and a rotor magnet has been known as a rotor used for a motor. In recent years, a configuration of the rotor in which the amount of use of the rotor magnet is reduced because of a rise in the price of the rotor magnet due to a rise in a price of the rare earth has been studied. Conventionally, a consequent-pole motor using a part of the rotor core as a pseudo pole has been known as a motor in which the amount of use of the rotor magnet of the rotor is reduced.

In general, in the consequent-pole motor using a part of the rotor core as a pseudo pole, imbalance of magnetic characteristics between respective magnetic poles is large, as compared to a general motor in which all magnetic poles are rotor magnets. That is, in the rotor of the consequent-pole motor, since the part of the rotor core is used as a magnetic pole, magnetic imbalance occurs between a magnetic pole configured with the rotor magnet and a magnetic pole configured with the part of the rotor core. In this way, when magnetic imbalance occurs in the rotor, cogging torque and torque ripple are generated in the motor.

In the consequent-pole motor, the reason why the magnetic imbalance occurs in the respective magnetic poles is as follows.

Since the magnetic pole configured with the part (a salient pole portion) of the rotor core does not have a compelling force for inducing a magnetic flux, the magnetic flux occurring on a rear surface of the rotor magnet flows through a part of the rotor core, which has low magnetic resistance. Thus, the magnetic flux may not equally flow through a plurality of salient pole portions depending on the shape of the salient pole portion of the rotor core. That is, since a direction and the amount of the magnetic flux flowing through the salient pole portions of the rotor core depend on the shapes of the salient pole portions, the rotor is magnetically unbalanced.

In contrast, conventionally, it has been known to form a slit in the rotor core to suppress deviation of the flow of the magnetic flux in the magnet and the salient pole portions on both sides of the magnet in the circumferential direction.

In detail, a magnet side slit extending radially to a radially inner end portion of the rotor core with the magnet as a radially outer end portion is formed radially inward of the magnet of the rotor core. Further, in the configuration, a salient pole side slit extending radially to the radially inner end portion of the rotor core is formed radially inward of a salient pole of the rotor core.

The rotor core is formed by bending a linearly continuous plate material for the rotor core into a circular shape. Therefore, the salient pole side slit is formed inside the rotor core without being opened on an outer circumferential surface of the salient pole of the rotor core.

In the conventional structure, when the slit formed inside the rotor core is not opened in the outer surface of the salient pole (the salient pole portion) of the rotor core, that is, when the outer surface of the salient pole portion of the rotor core is connected in the circumferential direction, flow of the magnetic flux is disturbed at the connected portion, and thus it is difficult to control the magnetic flux as designed.

### SUMMARY OF THE INVENTION

Example embodiments of the present disclosure alleviate magnetic imbalance of the rotor core by controlling the flow of the magnetic flux in the rotor core, and accordingly, reduce cogging torque and torque ripple generated in a motor.

A rotor according to an example embodiment of the present disclosure is a rotor including a rotor core in a cylindrical shape that includes a plurality of salient pole portions protruding in a radial direction and extends along a central axis, and a plurality of rotor magnets alternately arranged with the salient pole portions in a circumferential direction on a surface of the rotor core. The salient pole portions correspond to one magnetic pole of the rotor. The rotor magnets correspond to another magnetic pole of the rotor. The rotor core includes a core portion in a cylindrical shape extending along the central axis, a first space penetrating the core portion in an axial direction and located radially inward of the core portion with respect to the salient pole portions, a second space penetrating the core portion in the axial direction and located radially inward of the core portion with respect to the rotor magnets, and a slit extending from the first space to an outer surface of the salient pole portions and being open to the outer surface of the salient pole portions.

The above and other elements, features, steps, characteristics and advantages of the present disclosure will become more apparent from the following detailed description of the example embodiments with reference to the attached drawings.

### BRIEF DESCRIPTION OF THE DRAWINGS

FIG. 1 is a diagram illustrating a schematic configuration of a motor according to an example embodiment of the present disclosure.

FIG. 2 is a partially enlarged view illustrating a portion of the motor in an enlarged manner.

FIG. 3 is a diagram illustrating a configuration of a portion of a model of a rotor used for analysis.

FIG. 4a is a table illustrating calculation results of cogging torques.

FIG. 4b is a table illustrating calculation results of torque ripples.

FIG. 5 is a diagram corresponding to FIG. 3 in the case of an IPM motor.

FIG. 6a is a table corresponding to FIG. 4a in the case of the IPM motor.

FIG. 6b is a table corresponding to FIG. 4b in the case of the IPM motor.

FIG. 7 is a diagram corresponding to FIG. 1 of a motor according to another example embodiment of the present disclosure.

### DETAILED DESCRIPTION

Hereinafter, example embodiments of the present disclosure will be described in detail with reference to the drawings. The same or corresponding components in the drawings are denoted by the same reference numerals, and description thereof will not be repeated. Further, the dimensions of constituent members in each drawing do not reliably represent the actual dimensions of the constituent members and the dimensional ratios of the constituent members.

In the following description, a direction that is parallel to a central axis of a rotor is referred to as an “axial direction”, a direction that is perpendicular to the central axis of the rotor is referred to as a “radial direction”, and a direction along a circular arc with the central axis as a center is referred to as a “circumferential direction”. However, the definition of the directions is not intended to limit directions of the rotor and a motor according to the present disclosure at a time of use.

### (Entire Configuration)

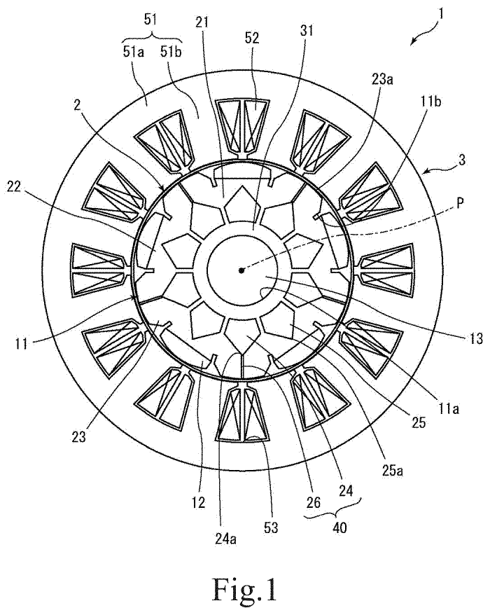

FIG. 1 illustrates a schematic configuration of a motor 1 according to an example embodiment of the present disclosure. The motor 1 includes a rotor 2 and a stator 3. As will be described later, the motor 1 is a so-called consequent-pole motor in which a part of a magnetic pole of the rotor 2 is configured with a rotor core 11. In the motor 1, the rotor 2 rotates about a central axis P with respect to the stator 3. In the present example embodiment, the motor 1 is an inner rotor type motor in which the columnar rotor 2 is rotatably disposed inside the cylindrical stator 3.

The rotor 2 includes the rotor core 11, a rotor magnet 12, and a rotary shaft 13.

The rotor core 11 has a cylindrical shape extending along the central axis P. The rotor core 11 is formed by laminating a plurality of electromagnetic steel plates formed in a predetermined shape in a thickness direction.

The rotor core 11 has a core portion 21 and a ring portion 31. The core portion 21 and the ring portion 31 have cylindrical shapes. The ring portion 31 extends along the central axis P, and has a through-hole 11a which the rotary shaft 13 penetrates. That is, the rotary shaft 13 is disposed inside the through-hole 11a. The through-hole 11a penetrates the rotor core 11 in an axial direction. The ring portion 31 has an annular cross section connected in a circumferential direction of the rotor core 11. The ring portion 31 is located further radially inward of the rotor core 11 than the first space 24 and the second space 25 provided in the core portion 21, which will be described later.

Accordingly, since the ring portion 31 of the rotor core 11 is directly connected to the rotary shaft 13, a decrease in rigidity of the rotor core 11 can be prevented. Moreover, since the ring portion 31 is connected in the circumferential direction of the rotor core 11, the rigidity of the rotor core 11 can be alleviated by the ring portion 31.

The core portion 21 has a cylindrical shape extending along the central axis P and located radially outward of the ring portion 31. That is, the core portion 21 is disposed concentrically with the ring portion 31. The core portion 21 and the ring portion 31 are formed integrally to constitute the rotor core 11.

The core portion 21 has a plurality of rotor magnet attaching units 22 and a plurality of salient pole portions 23 on an outer circumferential surface. The plurality of rotor magnet attaching units 22 and the plurality of salient pole portions 23 protrude outward in a radial direction of the core portion 21, respectively. The rotor magnet attaching units 22 and the salient pole portions 23 are alternately arranged in a circumferential direction of the core portion 21, that is, in the circumferential direction of the rotor core 11.

The rotor magnet 12 is fixed to the rotor magnet attaching unit 22. In detail, the rotor magnet attaching unit 22 protrudes radially outward of the core portion 21, and a tip end portion of the rotor magnet attaching unit 22 has a planar shape. The rotor magnet 12 is fixed to a tip end portion of the rotor magnet attaching unit 22. That is, the motor 1 according to the present example embodiment is a so-called surface permanent magnet (SPM) motor in which the rotor magnet 12 is disposed on an outer circumferential surface (a surface) of the rotor core 11. The rotor magnet 12 of the core portion 21 is the other magnetic pole of the rotor 2.

The salient pole portion 23 has a tapered shape in which as a tip end portion located outward in a radial direction of the rotor core 11 goes outward in the radial direction of the rotor core 11, the length of the rotor core 11 in a circumferential direction becomes smaller. The salient pole portion 23 is one magnetic pole of the rotor 2.

A slit 11b is configured between the rotor magnet attaching unit 22 and the salient pole portion 23 in the circumferential direction of the rotor core 11.

The rotor core 11 has a plurality of first spaces 24 and a plurality of second spaces 25 surrounded by the core portion 21. The rotor core 11 has a slit 26 (a slit portion) extending from each first space 24 to an outer surface 23a of each salient pole portion 23 and opened in the outer surface 23a of the salient pole portion 23. In this way, as the slit 26 that is opened in the outer surface 23a to the salient pole portion 23 of the rotor core 11 is provided, as will be described later, a magnetic flux generated in the salient pole portion 23 of the rotor core 11 by the rotor magnet 12 can be accurately controlled. Detailed configurations of the first space 24, the second space 25, and the slit 26 will be described below.

The stator 3 has a cylindrical shape. The rotor 2 is disposed inside the stator 3 to be rotatable about the central axis P. The stator 3 includes a stator core 51 and stator coils 52. The stator core 51 has a cylindrical yoke 51a and a plurality of teeth 51b extending radially inward from an inner surface of the yoke 51a, in a cross section that is perpendicular to the central axis P. The stator core 51 has slots 53 between the adjacent teeth 51b, respectively. The stator coils 52 are wound on the plurality of teeth 51b, respectively. That is, the stator coils 52 wound on the teeth 51b are positioned inside the plurality of slots 53.

In particular, although not illustrated, the stator coils 52 wound in the plurality of teeth 51b function as stator cores of each phase of the motor 1. Thus, when the stator coils 52 are energized, a rotational driving force is generated in the rotor 2 by a magnetic field generated by the stator coils 52 and a magnetic field generated by the rotor 2.

### (Configuration of First Space, Second Space, and Silt)

The rotor core 11 has a plurality of first spaces 24 and a plurality of second spaces 25 surrounded by the core portion 21. The plurality of first spaces 24 and the plurality of second spaces 25 penetrate the cylindrical core portion 21 in an axial direction. That is, the plurality of first spaces 24 and the plurality of second spaces 25 are partitioned by a part of the core portion 21. Each first space 24 and each second space 25 have a pentagonal shape in a cross section perpendicular to the central axis P. The plurality of first spaces 24 and the plurality of second spaces 25 are alternately arranged in a circumferential direction of the rotor core 11 at regular intervals.

The first space 24 is located radially inward of the core portion 21 with respect to the salient pole portion 23 in the cross section perpendicular to the central axis P of the rotor core 11. The first space 24 has a pentagonal shape in which a vertex 24a is located radially inward of the core portion 21 with respect to a central portion of the salient pole portion 23 in the circumferential direction of the core portion 21 in the cross section.

The second space 25 is located radially inward of the core portion 21 with respect to the rotor magnet 12 in the cross section perpendicular to the central axis P of the rotor core 11. The second space 25 has a pentagonal shape in which a vertex 25a is located radially inward of the core portion 21 with respect to a central portion of the rotor magnet 12 in the circumferential direction of the core portion 21 in the cross section. A part of the core portion 21 is located between the rotor magnet 12 and the second space 25. That is, a slit, which will be described below, is not provided between the rotor magnet 12 and the second space 25.

That is, in the first space 24 and the second space 25, in the cross section perpendicular to the central axis P of the rotor core 11, the vertexes 24a and 25a are located radially outward of the rotor core 11 in the first space 24 and the second space 25.

As the first space 24 and the second space 25 are configured as above, a variation in a magnetic flux generated in the rotor core 11 by the rotor magnet 12 can be further reduced. Thus, the magnetic flux generated in the rotor core 11 can be controlled more accurately.

In the present example embodiment, the first space 24 and the second space 25 have the same shape and the same size in the cross section perpendicular to the central axis P of the rotor core 11. Further, as described above, the plurality of first spaces 24 and the plurality of second spaces 25 are alternately arranged in a circumferential direction of the rotor core 11 at regular intervals. That is, in the first space 24 and the second space 25, in the cross section, a center of the first space 24 in the circumferential direction of the rotor core 11 and a center of the second space 25 in the circumferential direction of the rotor core 11 are arranged in the circumferential direction of the rotor core 11 at regular intervals. Accordingly, since it becomes easier to control flow of the magnetic flux of the rotor core 11, magnetic imbalance in the circumferential direction of the rotor core 11 can be suppressed.

The vertex 24a (an outer end) of the first space 24 and the vertex 25a (an outer end) of the second space 25 are located at the same position in the radial direction of the rotor core 11, in the cross section perpendicular to the central axis P of the rotor core 11. Accordingly, since it becomes easier to control flow of the magnetic flux of the rotor core 11, magnetic imbalance in the circumferential direction of the rotor core 11 can be suppressed. Here, the outer ends of the first space 24 and the second space 25 mean outermost portions of the rotor core 11 in the radial direction, that is, the vertexes 24a and 25a.

The position in the radial direction means a position of the rotor core 11 in the radial direction, in the cross section perpendicular to the central axis P of the rotor core 11. That is, the same position in the radial direction means the same distance from the central axis P in the radial direction of the rotor core 11 in the cross section.

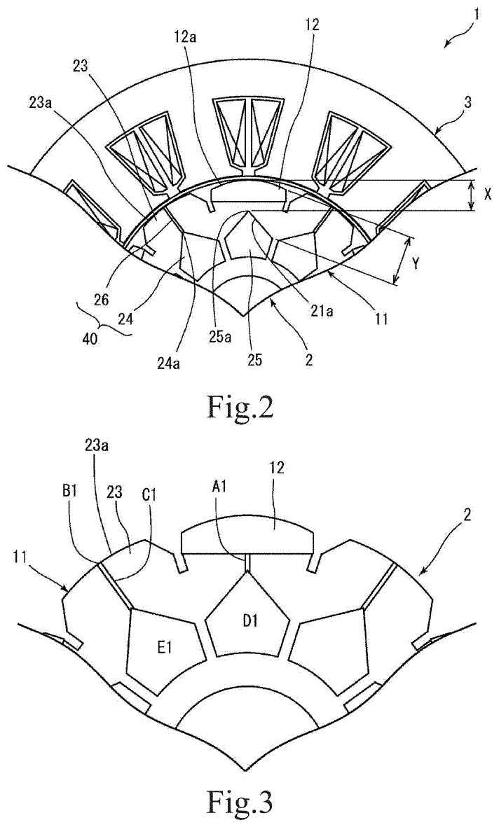

FIG. 2 is a partially enlarged view of the motor 1. As illustrated in FIG. 2, in the cross section perpendicular to the central axis P of the motor 1, a radial distance X between an inner surface 21a of the core portion 21 facing the second space 25 and an outer surface 12a of the rotor magnet 12 at a central position of the rotor magnet 12 in the circumferential direction of the rotor core 11 (the core portion 21) is shorter than a radial distance Y between the inner surface 21a facing the second space 25 of the rotor core 11 and the outer surface 12a of the rotor magnet 12 at an end position of the rotor magnet 12 in the circumferential direction. The radial distance X may be the same as the radial direction Y.

With the above-described configuration, an area where a magnetic flux is generated to connect the rotor magnet 12 and the salient pole portion 23 to each other can be formed inside the rotor core 11 by the second space 25. That is, with the above-described configuration, in the cross section perpendicular to the central axis P of the rotor core 11, an area where the magnetic flux flows in the core portion 21 at an end position of the rotor magnet 12 is larger than an area where the magnetic flux flows in the core portion 21 at the central position of the rotor magnet 12, so that the magnetic flow can flow from the rotor magnet 12 to the salient pole portion 23. However, the magnetic flux can be generated inside the rotor core 11 by the rotor magnet 12 while being efficiently controlled.

Here, the inner surface 21a is a surface of the core portion 21 by which the second space 25 is divided. That is, the second space 25 is configured by an area surrounded by the inner surface 21a.

The distance in the radial direction means a distance between two points of the rotor core 11 in the radial direction, in the cross section perpendicular to the central axis P of the rotor core 11.

As illustrated in FIGS. 1 and 2, the rotor core 11 has the slit 26 (the slit portion) formed inside the salient pole portion 23 to extend from the first space 24 in the radial direction of the rotor core 11. In the cross section perpendicular to the central axis P of the rotor core 11, the slit 26 extends from the vertex 24a of the first space 24 to an outer circumferential surface of the salient pole portion 23 and is opened in the outer circumferential surface. Accordingly, the salient pole portion 23 is divided into two parts in the circumferential direction of the rotor core 11 by the slit 26.

As the above-described slit 26 is provided in the salient pole portion 23, the magnetic flux generated in the salient pole portion 23 of the rotor core 11 by the rotor magnet 12 can be accurately controlled. That is, as the slit 26 extending from the first space 24 to the outer surface 23a of the salient pole portion 23 and opened in the outer surface 23a is provided in the salient pole portion 23 of the rotor core 11, in the cross section perpendicular to the central axis P of the rotor core 11, a range in which the magnetic flux is generated in the salient pole portion 23 by the rotor magnet 12 can be more reliably controlled.

Therefore, in the so-called consequent-pole motor in which the salient pole portion 23 and the rotor magnet 12 are alternately arranged in the rotor core 11, a direction and the amount of the magnetic flux generated in the rotor core 11 can be controlled. Thus, the magnetic flux generated in the rotor core 11 is more reliably controlled, so that cogging torque and the torque ripple generated in the motor 1 can be reduced.

In the present example embodiment, in the cross section perpendicular to the central axis P, the slit 26 is located a center of the salient pole portion 23 in the circumferential direction of the rotor core 11. Thus, the salient pole portion 23 is divided in half in the circumferential direction of the rotor core 11 by the slit 26. Accordingly, in the cross section, the magnetic flux density of the magnetic flux generated by the adjacent rotor magnets 12 can be equalized in two areas of the salient pole portion 23 divided by the slit 26. However, the cogging torque and the torque ripple generated in the motor can be reduced without being affected by the rotation direction of the rotor 2.

An inner side of the slit 26 in the radial direction of the rotor core 11 is connected to the first space 24. One space 40 is defined by the slit 26 and the first space 24. In the space 40, in the cross section perpendicular to the central axis P of the rotor core 11, the radially outward portion of the rotor core 11 has a smaller length in the circumferential direction of the rotor core 11 than the radially inner portion of the rotor core 11. Moreover, a part of the space 40 extends toward the outer surface 23a of the salient pole portion 23 and is opened in the outer surface 23a.

The width of the slit 26 in the circumferential direction of the rotor core 11 may be 0.3 mm or more. The width of the slit 26 is set to 0.3 mm or more, so that the slit 26 that can divide the salient pole portion 23 in the circumferential direction of the rotor core 11 can be formed in the rotor core 11.

Here, each of the first space 24 and the second space 25 has an air layer. Since the air layer has lower magnetic permeability than the rotor core 11, the flow of the magnetic flux is hindered by the first space 24 and the second space 25. The first space 24 and the second space 25 do not necessarily have air, and may be any area that has a larger magnetic resistance than the other portions in the rotor core 11. For example, substances other than the air may exist in the space. Similar to the slit 26, the slit 26 may have an air layer therein or substances other than the air may exist therein.

### (Effects of First Space, Second Space, and Slit)

Next, effects of the first space 24, the second space 25, and the slit 26 provided in the above-described rotor core 11 will be described.

As illustrated in FIG. 3, in a case where slits A1 and C1, a slit opening portion B1, a second space D1, and a first space E1 are provided in the rotor core 11 in which the rotor magnet 12 is disposed on an outer circumferential surface and in a case where the slits A1 and C1, the slit opening portion B1, the second space D1, and the first space E1 are not provided in the rotor core 11, differences in effects are confirmed from the viewpoint of the cogging torque and the torque ripple generated in the motor.

Here, the slit A1 is a slit connecting the second space and the rotor magnet. The slit C1 is a silt connecting the first space and an outer surface of a magnetic pole portion. The slit opening portion B1 is an opening portion of the slit connecting the first space and the outer surface of the magnetic pole portion. The slit opening portion B1 and the slit C1 correspond to the slit 26 in FIGS. 1 and 2. The first space E1 and the second space D1 correspond to the first space 24 and the second space 25 in FIGS. 1 and 2, respectively.

In the following description, a model of the motor illustrated in FIG. 3 is prepared, and calculated values of the cogging torque and the torque ripple generated in the motor are obtained by simulation of a finite element method using the model.

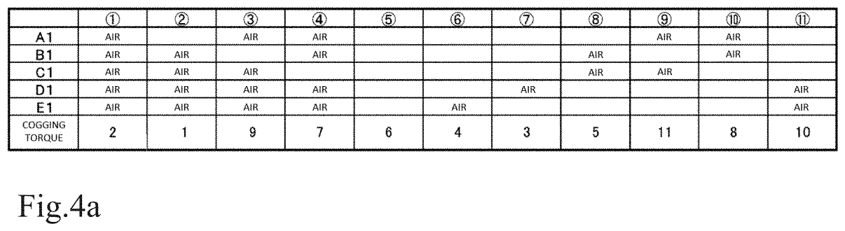

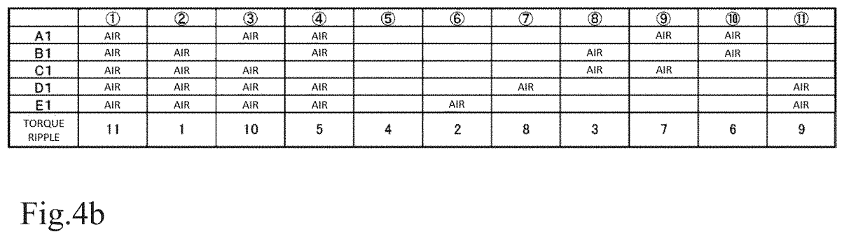

FIGS. 4a and 4b illustrate a result of the analysis. FIGS. 4a and 4b illustrate a result obtained by calculating the cogging torque and the torque ripple generated in the motor in totally 11 patterns among combinations of a case where the slits A1 and C1, the slit opening portion B1, the second space D1, and the first space E1 are “air”, respectively, and a case where the slits A1 and C1, the slit opening portion B1, the second space D1, and the first space E1 are metal (a state in which no space or slit is provided). In FIGS. 4a and 4b, the 11 patterns are indicated by circled numbers, respectively. In the following description, in FIGS. 4a and 4b, circled numerals 1 to 11 are referred to as pattern 1 to pattern 11, respectively.

FIG. 4a illustrates a result obtained by calculating the cogging torque generated in the motor. FIG. 4b illustrates a result obtained by calculating the ripple torque generated in the motor. In FIGS. 4a and 4b, a blanked space in a table indicates a case where each component is metal, that is, a case where a space or a slit is not provided in the rotor core. Further, in FIG. 4a, each number in a cogging torque column indicates an order in which a value of the cogging torque is small. Similarly, in FIG. 4b, each number in a torque ripple column indicates an order in which a value of the torque ripple is small.

As illustrated in FIGS. 4a and 4b, in the case of pattern 2 in which the slit A1 is not provided in the rotor core and the slit C1, the slit opening portion B1, the second space D1, and the first space E1 are provided in the rotor core, the cogging torque and the torque ripple generated in the motor is minimized.

However, in the above-described example embodiment, the following configuration is most preferable from the viewpoint of suppressing the cogging torque and the torque ripple generated in the motor.

The rotor core 11 has the first space 24 located radially inward of the rotor core 11 with respect to the salient pole portion 23 and the second space 25 located radially inward of the rotor core 11 with respect to the rotor magnet 12. Thus, the slit 26 extending from the first space 24 to the outer surface 23a of the salient pole portion 23 and opened in the outer surface 23a of the salient pole portion 23 is provided. Meanwhile, a slit is not provided between the rotor magnet 12 and the second space 25, that is, a portion of the core portion 21 of the rotor core 11 is located between the rotor magnet 12 and the second space 25.

With this configuration, the cogging torque and the torque ripple generated in the motor can be most suppressed.

As illustrated in FIGS. 4a and 4b, when an opening of the slit 26 is not provided on the outer surface 23a of the salient pole portion 23 (when B is not provided in FIG. 3, pattern 3 in FIGS. 4a and 4b), the cogging torque and the torque ripple generated in the motor are relatively large. Thus, as described above, it is required that the silt 26 extending from the first space 24 to the outer surface of the salient pole portion 23 is opened in the outer surface of the salient pole portion 23.

As illustrated in FIGS. 4a and 4b, even when the slit A1 is provided (pattern 1 in FIGS. 4a and 4b), the cogging torque generated in the motor can be suppressed, and thus a slit may be provided between the rotor magnet 12 and the second space 25.

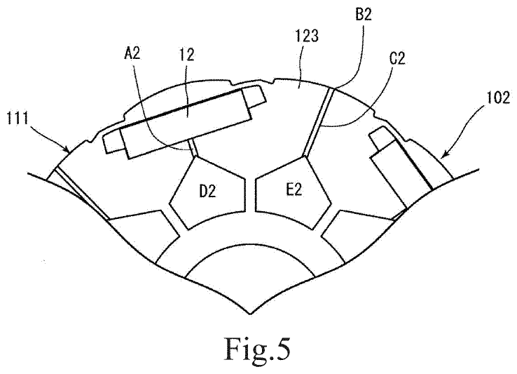

Next, as compared to the present example embodiment, as illustrated in FIG. 5, even in a configuration (an IPM (interior permanent magnet) motor) in which the rotor magnet 12 is disposed inside a rotor core 111, similarly, analysis of calculating the cogging torque and the torque ripple is performed.

A rotor 102 illustrated in FIG. 5 differs from the above-described rotor 2 illustrated in FIGS. 1 to 3 in that the rotor magnet 12 is disposed in the rotor core 111 and a protruding length of the salient pole portion 123 in the radial direction of the rotor core 111 is smaller than a protruding length of the above-described rotor 2 illustrated in FIGS. 1 to 3. Since the other configurations are the same as those of the above-described rotor 2 illustrated in FIGS. 1 to 3, detailed description will be omitted.

Even in the configuration illustrated in FIG. 5, in a case where slits A2 and C2, a slit opening portion B2, a second space D2, and a first space E2 are provided in the rotor core 111 and in a case where the slits A2 and C2, the slit opening portion B2, the second space D2, and the first space E2 are not provided in the rotor core 111, differences in effects are confirmed from the viewpoint of the cogging torque and the torque ripple generated in the motor.

Here, the slit A2 is a slit connecting the second space and the rotor magnet. The slit C2 is a silt connecting the first space and an outer surface of a magnetic pole portion. The slit opening portion B2 is an opening portion of the slit connecting the first space and the outer surface of the magnetic pole portion.

Analysis conditions and the like are the same as the above-described configuration illustrated in FIG. 3.

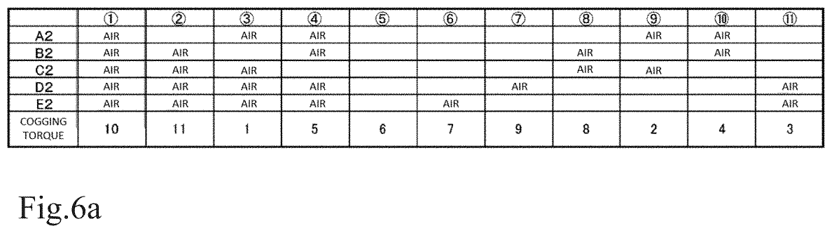

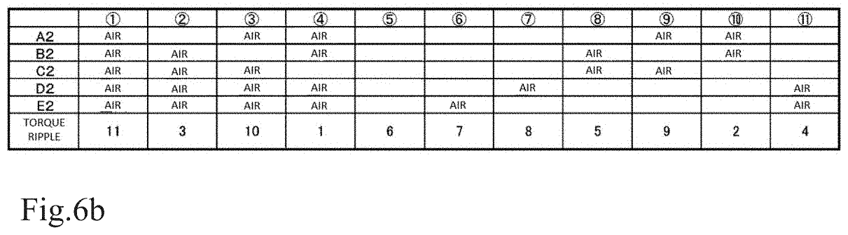

FIGS. 6a and 6b illustrate a result of the analysis. Similarly to FIGS. 4a and 4b, FIGS. 6a and 6b illustrate a result obtained by calculating the cogging torque and the torque ripple generated in the motor in totally 11 patterns among combinations of a case where the slits A2 and C2, the slit opening portion B2, the second space D2, and the first space E2 are “air”, respectively, and a case where the slits A2 and C2, the slit opening portion B2, the second space D2, and the first space E2 are metal (a state in which no space or slit is provided). Even in FIGS. 6a and 6b, the patterns 11 are indicated by circled numbers, respectively. In the following description, in FIGS. 6a and 6b, circled numerals 1 to 11 are referred to as pattern 1 to pattern 11, respectively.

FIG. 6a illustrates a result obtained by calculating the cogging torque generated in the motor. FIG. 6b illustrates a result obtained by calculating the ripple torque generated in the motor. Similarly to FIGS. 4a and 4b, in FIGS. 6a and 6b, a blanked space in a table indicates a case where each component is metal, that is, a case where a space or a slit is not provided in the rotor core. Further, even in FIG. 6a, each number in a cogging torque column indicates an order in which a value of the cogging torque is small. Similarly, even in FIG. 6b, each number in a torque ripple column indicates an order in which a value of the torque ripple is small.

As illustrated in FIGS. 6a and 6b, in the configuration in which the rotor magnet 12 is disposed inside the rotor core 111, an effect obtained by providing the slit C2 and the slit opening portion B2 (an effect of suppressing the cogging torque and the torque ripple generated in the motor) is smaller than that of the configuration shown in FIG. 3 (see patterns 1, 2, and 8). Meanwhile, when the slit C2 is not provided (pattern 4), the cogging torque and the torque ripple generated in the motor are further reduced.

In this way, in the configuration of the present example embodiment in which the slit 26 is provided, in the configuration (an SPM motor) in which the rotor magnet is disposed on the surface of the rotor core, the cogging torque and the torque ripple generated in the motor can be more effectively suppressed.

As described above, as the slit 26 is provided in the salient pole portion 23 of the rotor core 11, a magnetic flux generated in the salient pole portion 23 of the rotor core 11 by the rotor magnet 12 can be accurately controlled. That is, as the slit 26 extending from the first space 24 to the outer surface 23a of the salient pole portion 23 and opened in the outer surface 23a is provided in the salient pole portion 23 of the rotor core 11, in the cross section perpendicular to the central axis P of the rotor core 11, a range in which the magnetic flux is generated in the salient pole portion 23 by the rotor magnet 12 can be more reliably controlled.

Therefore, in the so-called consequent-pole motor in which the salient pole portion 23 and the rotor magnet 12 are alternately arranged in the rotor core 11, a direction and the amount of the magnetic flux generated in the rotor core 11 can be controlled. Thus, the magnetic flux generated in the rotor core 11 is more reliably controlled, so that cogging torque and torque ripple generated in the motor 1 can be reduced.

In the case of the present example embodiment, in the cross section perpendicular to the central axis P of the rotor core 11, the slit 26 is provided at a half position of the salient pole portion 23 in the circumferential direction of the rotor core 11. Thus, in the cross section, the magnetic flux density of the magnetic flux generated by the adjacent rotor magnets 12 can be equalized in two areas of the salient pole portion 23 divided by the slit 26. However, the cogging torque and the torque ripple generated in the motor can be reduced without being affected by the rotation direction of the rotor 2.

Further, in the cross section perpendicular to the central axis P of the rotor core 11, a radial distance X between an inner surface 21a of the core portion 21 facing the second space 25 and an outer surface 12a of the rotor magnet 12 at a central position of the rotor magnet 12 in the circumferential direction of the rotor core 11 (the core portion 21) is shorter than a radial distance Y between the inner surface 21a facing the second space 25 of the core portion 21 and the outer surface 12a of the rotor magnet 12 at an end position of the rotor magnet 12 in the circumferential direction.

Accordingly, an area where a magnetic flux is generated to connect the rotor magnet 12 and the salient pole portion 23 to each other can be formed inside the rotor core 11 by the second space 25. That is, with the above-described configuration, in the cross section perpendicular to the central axis P of the rotor core 11, an area where the magnetic flux flows in the core portion 21 at an end position of the rotor magnet 12 is larger than an area where the magnetic flux flows in the core portion 21 at the central position of the rotor magnet 12, so that the magnetic flow can flow from the rotor magnet 12 to the salient pole portion 23.

However, the magnetic flux can be generated inside the rotor core 11 by the rotor magnet 12 while being efficiently controlled.

In the above-described configuration, in the rotor 2, a part of the core portion 21 is located between the rotor magnet 12 and the second space 25. Accordingly, the magnetic flux generated in the rotor core 11 by the rotor magnet 12 can be controlled more accurately. However, the cogging torque and the torque ripple generated in the motor 1 can be reduced.

In the above-described configuration, each of the first space 24 and the second space 25 is partitioned by the part of the core portion 21. In the cross section perpendicular to the central axis P, the salient pole portion 23 and the rotor magnet 12 are disposed in the circumferential direction of the rotor core 11 at regular intervals. In the cross section perpendicular to the central axis P of the rotor core 11, the first space 24 and the second space 25 are disposed in the circumferential direction of the rotor core 11 at regular intervals.

Accordingly, the variation in the magnetic flux generated in the rotor core 11 by the rotor magnet 12 can be further reduced. Thus, the magnetic flux generated in the rotor core 11 can be controlled more accurately.

In the above-described configuration, in the cross section perpendicular to the central axis P, radial positions of outer ends of the first space 24 and the second space 25 in the radial direction of the rotor core 11 are the same. Accordingly, the variation in the magnetic flux generated in the rotor core 11 by the rotor magnet 12 can be further reduced. Thus, the magnetic flux generated in the rotor core 11 can be controlled more accurately.

In the above-described configuration, the motor 1 further includes a rotary shaft 13 extending along the central axis P. The rotor core 11 further includes a ring portion 31 having a through-hole 11a penetrating the rotor core 11 in the radial direction on a radially inner side of the rotor core 11 than the first space 24 and the second space 25. The rotary shaft 13 is disposed in the through-hole 11a.

Accordingly, since the ring portion 31 of the rotor core 11 is directly connected to the rotary shaft 13, a decrease in rigidity of the rotor core 11 can be prevented. Moreover, since the ring portion 31 is connected in the circumferential direction of the rotor core 11, the rigidity of the rotor core 11 can be alleviated by the ring portion 31.

In the above-described configuration, in the cross section perpendicular to the central axis P of the rotor core 11, the first space 24 has a pentagonal shape in which the vertex 24a is located radially inward of the rotor core 11 with respect to the central portion of the salient pole portion 23 in the circumferential direction of the rotor core 11. The second space 25 has a pentagonal shape in which the vertex 25a is located radially inward of the rotor core 11 with respect to a central portion of the salient pole portion 23 in the circumferential direction of the rotor core 11 in the cross section.

Accordingly, the variation in the magnetic flux generated in the rotor core 11 by the rotor magnet 12 can be further reduced. Thus, the magnetic flux generated in the rotor core 11 can be controlled more accurately.

### Another Example Embodiment

Hereinafter, although the example embodiment of the present disclosure has been described, the above-described example embodiment is merely an example for implementing the present disclosure. Thus, the present disclosure is not limited to the above-described example embodiment, and the above-described example embodiment can be appropriately modified and implemented without departing from the spirit of the disclosure.

In the present example embodiment, the rotor core 11 has the first space 24 located radially inward of the rotor core 11 with respect to the salient pole portion 23 and the second space 25 located radially inward of the rotor core 11 with respect to the rotor magnet 12. However, the first space may be located on a radially inner side of the rotor core with respect to the salient pole portion 23 and the rotor magnet 12, and the second space may be located on a radially inner side of the rotor core with respect to the salient pole portion 23 and the rotor magnet 12.

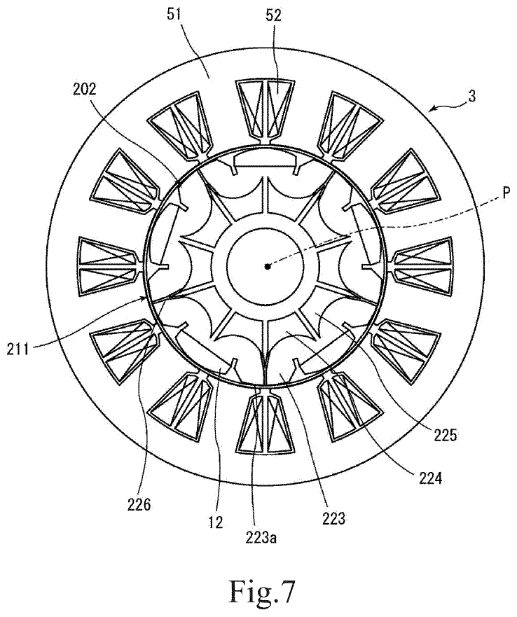

In detail, as illustrated in FIG. 7, in a rotor 202, a first space 224 is located on a radially inner side of a rotor core 211 with respect to a salient pole portion 223 and the rotor magnet 12, and a second space 225 is located on a radially inner side of the rotor core 211 with respect to the salient pole portion 223 and the rotor magnet 12.

That is, in the first space 224, a central portion of the rotor core 211 in the circumferential direction is located on a radially inner side of the rotor core 211 with respect to a circumferential midpoint of the rotor core 211 in the rotor magnet 12 and the salient pole portion 223. Further, in the second space 225, the central portion of the rotor core 211 in the circumferential direction is located on the radially inner side of the rotor core 211 with respect to the circumferential midpoint of the rotor core 211 in the salient pole portion 223 and the rotor magnet 12.

In the cross section perpendicular to the central axis P of the rotor core 211, each of the first space 224 and the second space 225 has a shape in which opposite ends of the rotor core 211 in the circumferential direction are located on a radially outer side of the rotor core 211 than the central portion of the rotor core 211.

A slit 226 (a slit portion) extending from the first space 224 to an outer surface 223a of the salient pole portion 223 and opened in the outer surface 223a of the salient pole portion 223 is connected to the first space 224. That is, the salient pole portion 223 is divided into two parts by the slit 226 in the circumferential direction of the rotor core 211. In the slit 226, an inner side of the rotor core 211 in the radial direction is connected not only to the first space 224 but also to the second space 225. That is, in the slit 226, the inner side of the rotor core 211 in the radial direction branches into two parts, and branched tip end portions are connected to the first space 224 and the second space 225, respectively.

Accordingly, the magnetic flux generated by the rotor magnet 12 flows in a region of the salient pole portion 223, divided by the slit 226. Thus, the flow of the magnetic flux in the rotor core 211 can be controlled. However, magnetic imbalance in the rotor core 211 can be alleviated, and the cogging torque and the torque ripple generated in the motor can be reduced.

In the slit 226, the inner side of the rotor core 211 in the radial direction may be connected to the first space 224 without being branched. That is, the slit 226 may obliquely divide the salient pole portion 223 when the central axis P is viewed from the axial direction. In this case, the plurality of slits 226 are inclined in the same direction in the circumferential direction of the rotor core 211. Accordingly, in a unidirectional rotation of the motor, the magnetic imbalance in the rotor core 211 can be alleviated. However, the cogging torque and the torque ripple generated in the motor rotating in one direction can be reduced.

In the present example embodiment, in the cross section perpendicular to the central axis P of the rotor core 11, the first space 24 and the second space 25 of the rotor core 11 have a pentagonal shape divided by the core portion 21. However, a first space and a second space may have shapes other than the pentagonal shape in the cross section. The first space and the second space are surrounded by, for example, a curved surface. Further, the first space and the second space may have different shapes and sizes in the cross section. The first space and the second space may be connected to each other. Outer ends of the first space and the second space mean outermost portions of the rotor core in the radial direction.

In the present example embodiment, the first space 24 and the second space 25 of the rotor core 11 are alternately arranged in the circumferential direction of the rotor core 11, and a center of the first space 24 and a center of the second space 25 are located at regular intervals. However, in the first space 24 and the second space 25, the center of the first space 24 and the center of the second space 25 may not be arranged at regular intervals.

In the present example embodiment, the motor 1 is an inner rotor-type motor in which the columnar rotor 2 is rotatably disposed in the cylindrical stator 3. However, the motor may be an outer rotor-type motor in which the cylindrical stator is arranged in the cylindrical rotor. Even in the case, as the cylindrical rotor core has the first space, the second space, and the slit, the same effects as the above example embodiment can be obtained. In this case, outer ends of the first space and the second space in the radial direction mean portions located on an innermost side in the radial direction of the rotor core.

The present disclosure can be used for a motor having a rotor in which rotor magnets and salient pole portions are alternately arranged on an outer surface thereof.

Features of the above-described preferred example embodiments and the modifications thereof may be combined appropriately as long as no conflict arises.

While example embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

1-9. (canceled)

10. A rotor comprising:
a rotor core with a cylindrical shape that includes a plurality of salient pole portions protruding in a radial direction, and extends along a central axis; and
a plurality of rotor magnets alternately arranged with the salient pole portions in a circumferential direction on a surface of the rotor core; wherein
the salient pole portions correspond to a first magnetic pole of the rotor;
the rotor magnets correspond to a second magnetic pole of the rotor; and
the rotor core includes:
a core portion in a cylindrical shape extending along the central axis;
a first space penetrating the core portion in an axial direction and located radially inward of the core portion with respect to the salient pole portions;
a second space penetrating the core portion in the axial direction and located radially inward of the core portion with respect to the rotor magnets; and
a slit portion extending from the first space to an outer surface of the salient pole portions and being open to the outer surface of the salient pole portions.

11. The rotor according to claim 10, wherein in the rotor core, in a cross section perpendicular to the central axis, a distance in the radial direction between an inner surface of the core portion facing the second space and the outer surface of the rotor magnets at a central position of the rotor magnets in the circumferential direction is equal to or less than a distance in the radial direction between the inner surface of the core portion facing the second space and the outer surface of the rotor magnets at an end portion position of the rotor magnets in the circumferential direction.

12. The rotor according to claim 10, wherein a portion of the core portion is located between the rotor magnets and the second space.

13. The rotor according to claim 10, wherein
each of the first space and the second space is partitioned by a portion of the core portion;
the salient pole portions and the rotor magnets are arranged at regular intervals in the circumferential direction in a cross section perpendicular to the central axis; and
the first space and the second space are arranged at regular intervals in the circumferential direction in the cross section perpendicular to the central axis.

14. The rotor according to claim 13, wherein positions of outer ends in the radial direction of the first space and the second space are identical in the radial direction in the cross section perpendicular to the central axis.

15. The rotor according to claim 10, further comprising:
a rotary shaft extending along the central axis; wherein
the rotor core includes a ring portion located farther radially inward than the first space and the second space and including a through-hole penetrating the rotor core in the axial direction; and
the rotary shaft is disposed inside the through-hole.

16. The rotor according to claim 10, wherein
the first space has a pentagonal shape, in a cross section perpendicular to the central axis, in which a vertex is located in the radial direction with respect to a central portion of the salient pole portions in the circumferential direction; and
the second space has a pentagonal shape, in the cross section perpendicular to the central axis, in which a vertex is located in the radial direction with respect to the central portion of the salient pole portions in the circumferential direction.

17. A rotor comprising:
a rotor core with a cylindrical shape including a plurality of salient pole portions on an outer circumferential surface and extending along a central axis; and
a plurality of rotor magnets alternately arranged with the salient pole portions in a circumferential direction on the outer circumferential surface of the rotor core; wherein
the salient pole portions correspond to a first magnetic pole of the rotor;
the rotor magnets correspond to a second magnetic pole of the rotor;
the rotor core includes:
a core portion; and
a space penetrating the core portion in an axial direction and located radially inward of the core portion with respect to the salient pole portions; and
in a cross section perpendicular to the central axis, a length in the space in the circumferential direction on an outer side in the radial direction is less than a length in the space in the circumferential direction on an inner side in the radial direction, and the space extends toward an outer surface of the salient pole portions and is open to the outer surface.

18. A motor comprising the rotor according to claim 10.
